(19) United States
(12) Patent Application Publication
(10) Pub. No.: US 2021/0321641 A1
(43) Pub. Date: Oct. 21, 2021

(54) METHOD FOR IMPROVING PERFORMANCE PARAMETERS OF AN ANIMAL

(71) Applicant: Avecho Biotechnology Limited, Clayton (AU)

(72) Inventor: Roksan Libinaki, Clayton (AU)

(21) Appl. No.: 17/353,343

(22) Filed: Jun. 21, 2021

Related U.S. Application Data
(63) Continuation of application No. 16/467,759, filed on Jun. 7, 2019, now abandoned.

(30) Foreign Application Priority Data
Dec. 9, 2016 (AU) 2016905085

(51) Int. Cl. A23K 20/174; A23K 50/30; A23K 50/60; A23K 50/75

(52) U.S. Cl. CPC A23K 20/174; A23K 50/30; A23K 50/60; A23V 2250/712; A23V 2002/00; A23V 2200/316; A23K 50/75

(57) ABSTRACT

The present invention relates to a method for improving performance parameters of an animal comprising administering to the animal a mixture of a mono-tocopheryl phosphate and a di-tocopheryl phosphate, wherein the di-tocopheryl phosphate is in a proportion of at least 10% by weight of the tocopheryl phosphate mixture.

### CROSS-REFERENCE TO RELATED APPLICATIONS

This application is a continuation of U.S. patent application Ser. No. 16/467,759, filed Jun. 7, 2019, which is a national stage filing under 35 U.S.C. 371 of International Application No. PCT/AU2017/051363, filed Dec. 11, 2017 which claims priority to Australian Patent Application No. 2016905085, filed Dec. 9, 2016, the disclosures of which are incorporated by reference herein in their entireties. Priority to each application is hereby claimed.

### TECHNICAL FIELD

The present invention relates to a method for improving performance parameters of an animal.

### BACKGROUND

In this specification where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

Vitamin E is an antioxidant that is used as a supplement for a variety of animals.

A majority of vitamin E supplements for animals utilise tocopherol acetate, generally in a synthetic form, due to its stability and cost effectiveness in such products.

U.S. Pat. No. 6,022,867 by Showa Denko discusses the need for a vitamin E source composition having a high absorption effect in animals, and which is easy to handle, is stable against heat, and is capable of dissolving in water. It suggests the potential benefits of a vitamin E source composition comprising tocopherol in a phosphorylated form represented by formula (I); the tocopheryl phosphate being synthetically-derived.

Specifically, Showa Denko teaches a high-purity tocopheryl phosphate or salt thereof having a tocopheryl phosphate purity of 95% or more, and containing 5% or less P,P′-bistocopheryl diphosphate, which is represented by formula (III), as an impurity.

Showa Denko relies on the high-purity tocopheryl phosphate or salt thereof of its vitamin E source composition for having an increased solubility in water and a pH in the neutral region so that it can be easily administered to animals.

Showa Denko demonstrates that animals fed their vitamin E source composition have improved effects compared with animals fed a vitamin E source comprising tocopheryl acetate. A number of animals including rainbow trout, yellow trout, mice and domestic fowl, had a growth acceleration effect. It was also noted that there was more vitamin E in the yolk of chicken eggs and reduced somatic cells in cows' milk, as a result of tocopheryl phosphate supplementation. It was further suggested that a variety of animals were also verified to have an action of vitamin E conversion (i.e. from the phosphate ester form to the free tocopherol form).

The present inventor has found that an alternate tocopheryl phosphate composition can be administered to animals to similarly improve an animal's performance parameters. Unlike Showa Denko's vitamin E source composition, the alternate tocopheryl phosphate composition is a stable, low-purity tocopheryl phosphate composition which, although it has poor water-solubility, can be easily administered to animals. The low-purity tocopheryl phosphate composition provides a useful alternative to known tocopheryl acetate and tocopheryl phosphate compositions, and may be more cost effective.

### SUMMARY

Accordingly, the present invention provides a method for improving a performance parameter of an animal comprising administering to the animal a mixture of a mono-tocopheryl phosphate and a di-tocopheryl phosphate, wherein the di-tocopheryl phosphate is in a proportion of at least 10% by weight of the tocopheryl phosphate mixture.

The animal may be selected from the group consisting of livestock animals, aqua-culture animals, working animals including sports animals, and domesticated companion animals. In particular embodiments, the animal is a juvenile.

The mixture of a mono-tocopheryl phosphate and a di-tocopheryl phosphate is preferably orally administered to the animal. For example, in one embodiment, the mixture of a mono-tocopheryl phosphate and a di-tocopheryl phosphate is added to a ration of animal feed to be consumed by the animal. The ration of animal feed is a starter diet, a finisher diet, or a combination of both.

In some embodiments, the ration of animal feed comprises a mixture of a mono-tocopheryl phosphate and a di-tocopheryl phosphate in an amount from about 1 ppm to about 1000 ppm. In other embodiments, the ration of animal feed comprises a mixture of a mono-tocopheryl phosphate and a di-tocopheryl phosphate in an amount from about 5 ppm to about 160 ppm, from 5 ppm to about 80 ppm, from about 5 ppm to about 60 ppm, from about 5 ppm to about 40 ppm, from about 5 ppm to about 30 ppm, from about 5 ppm to about 20 ppm, or from about 5 ppm to about 10 ppm. In further embodiments, the ration of animal feed comprises a mixture of a mono-tocopheryl phosphate and a di-tocopheryl phosphate in an amount from about 10 ppm to about 80 ppm, from 10 ppm to about 60 ppm, from about 10 ppm to about 50 ppm, from about 10 ppm to about 40 ppm, from about 10 ppm to about 30 ppm, or from about 10 ppm to about 20 ppm. In yet further embodiments, the ration of animal feed comprises a mixture of a mono-tocopheryl phosphate and a di-tocopheryl phosphate in an amount of about 5 ppm, about 10 ppm, about 20 ppm, about 40 ppm, or about 80 ppm.

In particular embodiments, the performance parameter is improved under stressed conditions in commercial production environments.

The performance parameter is a growth performance parameter. In some embodiments, the growth performance parameter is selected from the group consisting of live-weight gain and feed efficiency (e.g. selected from average daily gain, average daily feed intake and feed conversion ratio). In other embodiments, the performance parameter is improved meat quality.

### DETAILED DESCRIPTION

The present invention relates to a method for improving a performance parameter of an animal comprising administering to the animal a mixture of a mono-tocopheryl phosphate and a di-tocopheryl phosphate.

### Tocopheryl Phosphate Mixture

The mono-tocopheryl phosphate may be represented, for example, by the Formula I:

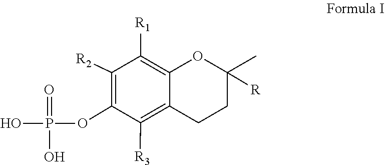

The di-tocopheryl phosphate may be represented, for example, by the Formula II:

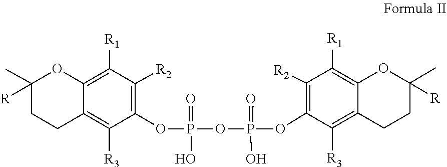

In Formula I and Formula II, each R1 to R3 independently represents a methyl group or a hydrogen atom, and R represents —(CH₂CH₂CH₂CH(CH₃))₃—.

The mixture of a mono-tocopheryl phosphate and a di-tocopheryl phosphate may be prepared by phosphorylating tocopherol with a phosphorylating agent (e.g. P₄O₁₀), wherein a covalent bond is formed between the oxygen atom (typically originating from a hydroxyl group) of the tocopherol and a phosphorous atom of a phosphate group of the phosphorylating agent.

The tocopherol may be α-, β-, γ-, or δ-tocopherol. In one embodiment, the mixture of a mono-tocopheryl phosphate and a di-tocopheryl phosphate is derived from α-tocopherol.

Further, the mixture of a mono-tocopheryl phosphate and a di-tocopheryl phosphate may be derived from a natural form of tocopherol, a synthetic form of tocopherol, or mixtures thereof. In one embodiment, the mixture of a mono-tocopheryl phosphate and a di-tocopheryl phosphate is derived from a natural form of tocopherol. In another embodiment, the mixture of a mono-tocopheryl phosphate and a di-tocopheryl phosphate is derived from a synthetic form of tocopherol.

The mono-tocopheryl phosphate and/or the di-tocopheryl phosphate may also be converted into a salt. Examples of salts include alkali metal salts, alkaline earth metal salts, and ammonium salts. In some embodiments, the mono-tocopheryl phosphate and/or the di-tocopheryl phosphate is a sodium salt, a magnesium salt, potassium salt, or a calcium salt.

The mixture of a mono-tocopheryl phosphate and a di-tocopheryl phosphate comprises the di-tocopheryl phosphate in a proportion of at least 10% by weight of the tocopheryl phosphate mixture.

In some embodiments, the proportion of the di-tocopheryl phosphate may be at least 20% by weight of the tocopheryl phosphate mixture, at least 30% by weight of the tocopheryl phosphate mixture, or at least 40% by weight of the tocopheryl phosphate mixture. In one embodiment, the proportion of the di-tocopheryl phosphate is about 50% by weight of the tocopheryl phosphate mixture.

In some embodiments, the mixture of a mono-tocopheryl phosphate and a di-tocopheryl phosphate may have a weight ratio of mono-tocopheryl phosphate to di-tocopheryl phosphate of about 2:1.

### Animal

The animal may be selected from the group consisting of livestock animals, aqua-culture animals, working animals including sports animals, and domesticated companion animals.

Broadly, the term “livestock animals” refers to any breed or population of animals kept by humans for useful, commercial production purposes. For example, the livestock animals may be for the purpose of breeding (e.g. bulls and cows), producing food products (e.g. meat, milk and eggs), producing animal products (e.g. wool), and/or providing labour or performing tasks (e.g. mules and cattle dogs). For these reasons, livestock animals may also be referred to as “production animals”.

The livestock animals may be selected from the group consisting of addaxes, alpacas, antelopes, bison, camels, cows (including dairy cows and beef cattle), deer, donkeys, elands, elks, gayals, goats, giraffes, horses, llamas, moose, mules, oxen, pigs, rabbits, sheep, water buffaloes, yaks, and zebus.

The livestock animals may also be poultry selected from the group consisting of chickens, doves, ducks, emus, goose, peafowls, swans, ostriches, pigeons, quails, turkeys, grey francolins, guinea fowls, pheasants, greater rheas, and squabs.

The aqua-culture animals, which are also farmed for commercial production purposes, include fish, molluscs, and crustaceans. The fish may be selected from the group consisting of carp including grass carp, silver carp, common carp, bighead carp, Indian carp, crucian carp and black carp, eel, nile tilapia, salmon including Atlantic salmon, roho labeo, milkfish, trout including rainbow trout, bream, northern snakehead, and catfish. The molluscs may be selected from the group consisting of abalones, oysters, mussels, pippies, clams cockles, periwinkles, and snails. The crustaceans may be selected from the group consisting of shrimp, prawns, crabs, crayfish, and lobsters.

The term “working animals” is generally used to describe animals that provide labour or perform tasks. Examples include, but are not limited to, camels, dogs, donkeys, elephants, horses, mules, and oxen.

Animals in sports are generally considered a specific type of working animal. Many animals, at least in more commercial sports, are highly trained. Examples of “sports animals” include, but are not limited to, camels, dogs, and horses.

The term “companion animals” refers to animals that have been domesticated by humans to live and breed in a tame condition and to depend on human-kind for survival. The companion animals may be mammals, birds, or fish. Examples of companion mammals include, but are not limited to, alpacas, cows, donkeys, dogs, cats, foxes, sheep, horses, goats, elephants, rodents including rats, mice, hamsters, guinea pigs, gerbils and chinchillas, ferrets, llamas, pigs, and rabbits. Examples of companion birds include, but are not limited to, parrots, canaries, chickens, turkeys, ducks, geese, pigeons, doves, finches, and birds of prey. Examples of companion fish include, but are not limited to, goldfish, koi, Siamese fighting fish, barb, guppy, betta, and molly.

In some embodiments, the animal may be juvenile (e.g. immature or subadult animals, such as newly weaned pigs or piglets, hatchlings/chicks, calves, cubs, pups, and the like) or established (e.g. an animal that has reached adult stage, such as pig, chicken, dairy cow, and the like).

### Method

The method for administering a mixture of a mono-tocopheryl phosphate and a di-tocopheryl phosphate to an animal is not particularly limited.

In some embodiments, a mixture of a mono-tocopheryl phosphate and a di-tocopheryl phosphate may be administered topically. For example, applied or pasted onto the skin or mucous membrane of an animal.

In other embodiments, a mixture of a mono-tocopheryl phosphate and a di-tocopheryl phosphate may be administered parenterally, e.g. by injection or infusion, after dilution with an appropriate solvent.

In other embodiments, a mixture of a mono-tocopheryl phosphate and a di-tocopheryl phosphate may be orally administered to the animal. The mixture of a mono-tocopheryl phosphate and a di-tocopheryl phosphate may be orally administered to the animal in its original form (e.g. as a powder), or in an oral formulation, which comprises a mixture of a mono-tocopheryl phosphate and a di-tocopheryl phosphate and a suitable carrier (e.g. a cereal-based carrier, fermented apples, and molasses).

In another embodiment, a mixture of a mono-tocopheryl phosphate and a di-tocopheryl phosphate may be orally administered to an animal via consumption of its feed. In other words, a mixture of a mono-tocopheryl phosphate and a di-tocopheryl phosphate could be added to, or formulated with, a feed to be consumed by the animal. There are many conventional and/or commercially available feeds for consumption by animals. The term “animal feed” may refer to a regular feed, a starter feed, a grower feed, or a finisher feed, as well as a feed additive, feed premix, or blend. Animal feeds and feed additives are available in a variety of forms, such powders, granules, pellets, flakes, crumbles, blocks, gels, liquids, solutions, pastes, drenches, and mixtures thereof. Animal feeds may also be in an unprocessed form (e.g. raw grains and naturally dried straw).

In general, an animal feed may comprise: (i) carbohydrates and fats to maintain the body and produce (milk, meat, work), (ii) protein for body building (growth) and maintenance as well as milk production, (iii) minerals to help in body building as well as in biological regulation of growth and reproduction, (iv) vitamins to help regulate the biological processes in the body and become a source of nutrients in milk and/or (v) water to help with all over in body building, heat regulation, and biological processes.

The actual composition of an animal feed will depend on the type of animals being fed and their stage of production, purpose, and/or use (e.g. performance parameter to be achieved). For example, a “broiler” may be fed an animal feed of suitable composition for a period of time post-hatching, e.g. starter diet, followed by an animal feed of suitable composition for the remainder of their growth period, e.g. finisher diet. The term “broiler” is used to describe a chicken grown for their meat.

Animals, such as those contemplated, are typically fed a recommended allowance of feed per day, usually referred to as a “ration”. Like the composition of an animal feed, the animal feed ration (i.e. the fixed (recommended) allowance of feed per day) will also depend on the type of animal being fed and their stage of production, purpose, and/or use (e.g. performance parameter to be achieved).

A ration of an animal feed may comprise a mixture of a mono-tocopheryl phosphate and a di-tocopheryl phosphate in an amount from about 1 ppm to about 1000 ppm.

In some embodiments, a ration of an animal feed may comprise a mixture of a mono-tocopheryl phosphate and a di-tocopheryl phosphate in an amount from about 1 ppm to about 500 ppm, from about 1 ppm to about 200 ppm, or from about 1 ppm to about 100 ppm.

In some embodiments, a ration of an animal feed may comprise a mixture of a mono-tocopheryl phosphate and a di-tocopheryl phosphate in an amount from about 5 ppm to about 160 ppm, from 5 ppm to about 80 ppm, from about 5 ppm to about 60 ppm, from about 5 ppm to about 40 ppm, from about 5 ppm to about 30 ppm, from about 5 ppm to about 20 ppm, or from about 5 ppm to about 10 ppm.

In further embodiments, a ration of an animal feed may comprise a mixture of a mono-tocopheryl phosphate and a di-tocopheryl phosphate in an amount from about 10 ppm to about 80 ppm, from 10 ppm to about 60 ppm, from about 10 ppm to about 50 ppm, from about 10 ppm to about 40 ppm, from about 10 ppm to about 30 ppm, or from about 10 ppm to about 20 ppm.

In other embodiments, a ration of an animal feed may comprise a mixture of a mono-tocopheryl phosphate and a di-tocopheryl phosphate in an amount of about 5 ppm, about 10 ppm, about 20 ppm, about 40 ppm, or about 80 ppm.

In one embodiment, a ration of an animal feed may comprise a mixture of a mono-tocopheryl phosphate and a di-tocopheryl phosphate in an amount of about 40 ppm. This amount could be appropriate, for example, in a “starter diet” for a pig, more specifically a “weaner” pig, during the first 14 days post-weaning. The term “weaner” is generally used to refer to nursery pigs. These pigs are immature and mark the loss of the maternal relationship, movement to a new environment, change of diet, and mixing of pigs, all of which are physical and behavioural challenges representing a high risk/challenging time for disease occurrence and set-backs in growth. Accordingly, the initial 14 days post-weaning is a critical period because weaning is a stressful experience for young piglets, often affecting them both socially and physiologically, which can in turn result in poor growth performance or even death. Therefore, significantly improving growth performance is likely to improve the further/future growth performance of a pig over its remaining lifespan, and improve its overall health status and/or incidence of death in the pig herd attributed to the affects experienced by the piglets during weaning.

In another embodiment, a ration of animal feed may comprise a mixture of a mono-tocopheryl phosphate and a di-tocopheryl phosphate in an amount of about 10 ppm. This amount could be appropriate, for example, for a broiler, in a starter diet and/or a finisher diet, to provide a fast-steady growth.

Accordingly, in some embodiments, the present invention may be particularly beneficial to livestock animals, especially juveniles, generally from birth up to reaching adult stage, when it is highly desirous to improve or optimise performance parameters.

This is particularly important in commercial production environments, where such animals experience multiple challenges due to the increased stress or demands placed on them (e.g. change in diet; environmental changes and stresses, such as heat stress; health, bacterial and viral/infection challenges; psychological/physiological, e.g. weaning/separation from their mother; socialisation and mixing of animals/pens/housing conditions). Established animals would also experience the same or similar challenges. It is therefore important, in any commercial production environment, to improve or optimise performance parameters to ensure the health and development of the animal. The present invention prevents, or at the very least minimises, the effects that may be experienced by animals in commercial production environments.

### Performance Parameters

The method may improve one or more performance parameters of an animal.

In some embodiments, the performance parameter may be growth performance including live-weight gain, and feed efficiency such as average daily gain (ADG), average daily feed intake (ADFI) and feed conversion ratio (FCR). In these embodiments, the performance parameter is likely to be more relevant to animals for commercial production purposes such as livestock animals and aqua-culture animals, possibly as a result of improved gut health, e.g. digestability, in such environments.

In other embodiments, the performance parameter may be relevant to the commercial production of food products, or animal products (e.g. meat, milk, and/or eggs, or wool). For example, with respect to meat, the performance parameter may be an improved meat quality such as retention of moisture and/or tenderness. In a particular embodiment, the commercial production of food products, or animal products, produced under stressed conditions in commercial production environments.

In further embodiments, the performance parameter may be relevant to improved fertility (e.g. improve conception rates and/or lower rates of deformity or still borns). In these embodiments, the performance parameter may be particularly relevant to livestock animals, working animals including sports animals, and domesticated companion animals, kept for commercial production purposes.

In yet other embodiments, the performance parameter may be relevant to health and well-being, including, for example, an improved immune benefit, reduced anxiety levels, or reduced stress response, especially in commercial conditions (e.g. heat stress, bacterial infection, and/or susceptibility to infections). These embodiments are likely to be relevant to any kind of animal.

In further embodiments, the performance parameter may be relevant to an improved ability, including stamina, agility, and memory. Such embodiments may be relevant to any kind of animal, but possibly of particular relevance to working animals including sports animals, and domesticated companion animals.

In this specification, except where the context requires otherwise, the words “comprise”, “comprises”, and “comprising” mean “include”, “includes”, and “including” respectively, i.e. when the invention is described or defined as comprising specified features, various embodiments of the same invention may also include additional features.

### EXAMPLES

The present invention will now be described with reference to the following non-limiting examples.

### Example 1

A mixture of a mono-tocopheryl phosphate and a di-tocopheryl phosphate according to the present invention was prepared by forming an intimate mixture of natural α-tocopherol and P₄O₁₀ at a temperature below 80° C., and allowing the intimate mixture to continue to react for a period of time at this temperature until formation of a mixture of mono-tocopheryl phosphate and a di-tocopheryl phosphate was substantially formed.

This process was also used to prepare a mixture of mono-tocopheryl phosphate and a di-tocopheryl phosphate derived from a synthetic form of tocopherol.

### Example 2

The following study was conducted to determine the effect of a mixture of a mono-tocopheryl phosphate and a di-tocopheryl phosphate administered to male “weaner” pigs, compared to a synthetic tocopheryl acetate.

### Treatment Groups

There were 5 treatment groups outlined below in the feed section, or a total of 945 pigs. There were 14 replicate pens per treatment group, with 13 or 14 pigs per pen (i.e. about 189 pigs per treatment group).

### Treatment Period

The treatment period was 14 days (from weaning to 14 days post-weaning).

### Diets

Each treatment group of pigs was fed a starter diet for the 14 days (i.e. Day 0-14).

All diets were prepared under supervision 7 days prior to the commencement of the study.

A single base diet was prepared as a mash, and this single base diet was then used to prepare the starter diets, as follows:

A=control diet (i.e. the base diet), which comprised a feed ration with 20 ppm tocopheryl acetate derived from a Base Premix
I=control diet, with 5 ppm of a mixture of a mono-tocopheryl phosphate and a di-tocopheryl phosphate added
II=control diet, with 10 ppm of a mixture of a mono-tocopheryl phosphate and a di-tocopheryl phosphate added
III=control diet, with 20 ppm of a mixture of a mono-tocopheryl phosphate and a di-tocopheryl phosphate added
IV=control diet, with 40 ppm of a mixture of a mono-tocopheryl phosphate and a di-tocopheryl phosphate added

TABLE A
Composition of single base diet

| Component | Inclusion (%) |
|---|---|
| Wheat | 10.16 |
| Groats | 11.0 |
| Steam flaked wheat | 23.0 |
| Barley | 20.17 |
| Soya protein concentrate | 4.10 |
| NuPro Yeast Extract | 3.33 |
| Meat and Bone meal 62% | 1.67 |
| Fishmeal 63% | 6.10 |
| Bloodmeal | 3.00 |
| Lactose | 10.00 |
| Water | 1.00 |
| Molasses | 2.00 |
| Tallow | 1.67 |
| Salt | 0.233 |
| Lysine-HCL | 0.45 |
| DL-Methionine | 0.237 |
| Threonine | 0.25 |
| Isoleucine | 0.147 |
| Tryptophan | 0.067 |
| L-Valine | 0.01 |
| Choline chloride | 0.10 |
| Zinc Oxide | 0.25 |
| Vevovital | 0.40 |
| Sucram | 0.015 |
| Betaine anhydrous | 0.10 |
| Rovabio Maxima 10% | 0.05 |
| Base Premix (see Table B) | 0.50 |

TABLE B
Base premix composition

| Component | Activity/inclusion per T |
|---|---|
| Antioxidant, g | 100 |
| Total Copper, g^{∧} | 20 |
| Total Iron, g^{∧} | 100 |
| Total Zinc, g^{∧} | 140 |
| Total Manganese, g^{∧} | 50 |
| Total Cobalt, g^{∧} | 0.2 |
| Total Iodine, g | 0.8 |
| Total Selenium, g^{∧} | 0.3 |
| Total Chromium, g | 0.2 |
| Vitamin A, MIU | 7.5 |
| Vitamin D3, MIU | 1.5 |
| Vitamin E, g | 20 |
| Vitamin K, g | 2.0 |
| Vitamin B1, g | 1.5 |
| Vitamin B2, g | 5.0 |
| Vitamin B3, g | 25 |
| Vitamin B5, g | 32.2 |
| Vitamin B6, g | 3.0 |
| Vitamin B9, g | 0.75 |
| Vitamin B12, mg | 20 |
| Biotin, mg | 100 |
| Limestone, kg | 1.5 |
| Dicalcium phosphate, kg | 0.3 |
| Cereal base carrier | To make up 5 kg |

^{∧}provided in an inorganic form.

### Results

The following tables provide the results of growth performance parameters, including live-weight gain, average daily gain (ADG), average daily feed intake (ADFI), and feed conversion ratio (FCR).

Table 1 shows the average live-weight gain (kg)

| | A | I | II | III | IV |
|---|---|---|---|---|---|
| D0 | 7.25 | 7.25 | 7.25 | 7.25 | 7.25 |
| D14 | 9.76 | 9.95 | 9.81 | 9.87 | 10.07 |

Table 2 shows the ADG (kg)

| | A | I | II | III | IV |
|---|---|---|---|---|---|
| D0-14 | 0.18 | 0.19 | 0.18 | 0.19 | 0.20 |

Table 3 shows the ADFI (kg)

| | A | I | II | III | IV |
|---|---|---|---|---|---|
| D0-14 | 0.25 | 0.25 | 0.23 | 0.23 | 0.24 |

Table 4 shows the FCR (feed:weight ratio)

| | A | I | II | III | IV |
|---|---|---|---|---|---|
| D0-14 | 1.37 | 1.26 | 1.25 | 1.23 | 1.17 |

At the end of the treatment period, the pigs administered a mixture of a mono-tocopheryl phosphate and a di-tocopheryl phosphate were heavier than the pigs administered the control diet.

In addition, the pigs administered a mixture of a mono-tocopheryl phosphate and a di-tocopheryl phosphate at any dose experienced more efficient utilisation of feed relative to the pigs offered the control diet, with the best feed conversion ratio achieved in pigs offered 40 ppm of a mixture of a mono-tocopheryl phosphate and a di-tocopheryl phosphate.

### Conclusion

The study demonstrated that a mixture of a mono-tocopheryl phosphate and a di-tocopheryl phosphate directly improved the feed conversion ratio in pigs by at least 14.6% (see Table 4, A vs IV, 1.37 vs 1.17). Furthermore, as shown by the results in Table 4, the pigs administered a mixture of a mono-tocopheryl phosphate and a di-tocopheryl phosphate showed a linear dose response to increasing levels of the mixture of a mono-tocopheryl phosphate and a di-tocopheryl phosphate.

### Example 3

The following study was conducted to determine the effect of a mixture of a mono-tocopheryl phosphate and a di-tocopheryl phosphate administered to broilers, compared to a synthetic tocopheryl acetate.

### Treatment Groups

Twelve cages of chickens per treatment, each cage containing 6 chickens (i.e. 72 chickens per treatment). Six treatment groups were assessed. A total of 432 chickens were used in the study.

### Treatment Period

The treatment period was 28 days.

### Diets

Each group of chickens was fed a treatment diet for 28 days post-hatching. More specifically, a starter diet for 14 days post-hatching (i.e. Day 1-14) and then a finisher diet for the next 14 days post-hatching (i.e. Day 15-28), as follows:

aa=control diet, which comprised a feed ration and no vitamin E source (i.e. not in either starter diet nor finisher diet)
A=control diet, with 20 ppm tocopheryl acetate added
I=control diet, with 5 ppm of a mixture of a mono-tocopheryl phosphate and a di-tocopheryl phosphate added
II=control diet, with 10 ppm of a mixture of a mono-tocopheryl phosphate and a di-tocopheryl phosphate added
III=control diet, with 20 ppm of a mixture of a mono-tocopheryl phosphate and a di-tocopheryl phosphate added
IV=control diet, with 40 ppm of a mixture of a mono-tocopheryl phosphate and a di-tocopheryl phosphate added

TABLE C
Diet compositions

| | Starter diet (D0-14 days | | Grower/Finisher diet (D15- | |
|---|---|---|---|---|
| | post-hatching) | | 28 days post-hatching) | |
| Raw Ingredient | % | (kg) | % | (kg) |
| Wheat | 67.95 | 679.5 | 69.61 | 696.1 |
| Soyabean meal | 22.0 | 220.0 | 20.0 | 200.0 |
| Meat meal | 6.0 | 60.0 | 5.6 | 56.0 |
| Blood meal | 0.8 | 8.0 | 0.4 | 4.0 |
| Soya oil | 1.1 | 11.0 | 2.6 | 26.0 |
| Salt | 0.06 | 0.6 | 0.09 | 0.9 |
| Limestone | 0.73 | 7.3 | 0.59 | 5.9 |
| Sodium | 0.26 | 2.6 | 0.24 | 2.4 |
| bicarbonate | | | | |
| Lysine-HCl | 0.35 | 3.5 | 0.28 | 2.8 |
| D,L-methionine | 0.31 | 3.1 | 0.26 | 2.6 |
| Threonine | 0.14 | 1.4 | 0.1 | 1.0 |
| Isoleucine | 0.09 | 0.9 | 0.05 | 0.5 |
| L-arginine | 0.05 | 0.5 | 0.02 | 0.2 |
| Choline chloride | 0.04 | 0.4 | 0.04 | 0.4 |
| Econase | 0.01 | 0.1 | 0.01 | 0.1 |
| Phytase | 0.01 | 0.1 | 0.01 | 0.1 |
| Poultry premix # | 0.1 | 1.0 | 0.1 | 1.0 |
| | 100.0 | 1000.0 | 100.0 | 1000.0 |

# Poultry premix comprised a range of final inclusion of vitamin E (e.g. treatment diet A comprised 0.02 kg/t tocopheryl acetate, or 20 ppm tocopheryl acetate, whereas treatment diets I-IV comprised 0.005-0.04 kg/t of a mixture of a mono-tocopheryl phosphate and a di-tocopheryl phosphate, or 5-40 ppm of a mixture of a mono-tocopheryl phosphate and a di-tocopheryl phosphate). As noted above, the control diet (aa) did not comprise any vitamin E source.

### Results

The following tables provide the results of various growth performance parameters.

Table 1 shows the average live-weight gain (g)

| Day | aa | A | I | II | III | IV |
|---|---|---|---|---|---|---|
| 0 | 44.7 | 44.8 | 45.0 | 44.4 | 44.2 | 44.3 |
| 7 | 163.3 | 166.0 | 162.1 | 166.7 | 167.1 | 167.8 |
| 14 | 496.9 | 505.1 | 497.3 | 511.8 | 512.0 | 511.6 |
| 21 | 1003.7 | 1052.0 | 1039.5 | 1059.8 | 1076.9 | 1073.8 |
| 28 | 1745.6 | 1807.1 | 1771.5 | 1843.1 | 1809.7 | 1801.5 |

Table 2 shows the ADG (g)

| Day | aa | A | I | II | III | IV |
|---|---|---|---|---|---|---|
| 0-14 | 32.80 | 32.96 | 32.37 | 33.27 | 33.35 | 33.32 |
| 15-28 | 89.22 | 92.92 | 91.18 | 95.01 | 92.53 | 92.23 |
| 0-28 | 60.75 | 63.00 | 61.74 | 64.20 | 62.89 | 62.62 |

Table 3 shows the ADFI (g)

| Day | aa | A | I | II | III | IV |
|---|---|---|---|---|---|---|
| 0-14 | 38.78 | 39.20 | 38.09 | 38.69 | 39.06 | 38.90 |
| 15-28 | 127.92 | 130.04 | 127.89 | 130.34 | 131.86 | 131.51 |
| 0-28 | 83.35 | 84.62 | 82.99 | 84.51 | 85.46 | 85.20 |

Table 4 shows the FCR (feed:weight ratio)

| Day | aa | A | I | II | III | IV |
|---|---|---|---|---|---|---|
| 0-14 | 1.184 | 1.191 | 1.176 | 1.164 | 1.172 | 1.168 |
| 15-28 | 1.435 | 1.404 | 1.407 | 1.381 | 1.416 | 1.422 |
| 0-28 | 1.363 | 1.347 | 1.341 | 1.320 | 1.350 | 1.350 |

### Conclusion

The study demonstrated a statistically significant reduction in feed conversion ratio with the groups of chickens fed a treatment diet comprising a mixture of a mono-tocopheryl phosphate and a di-tocopheryl phosphate. The optimum treatment diet comprised an amount of 10 ppm of a mixture of a mono-tocopheryl phosphate and a di-tocopheryl phosphate (or 10 mg of a mixture of a mono-tocopheryl phosphate and a di-tocopheryl phosphate/kg feed).

### Example 4

The meat quality (tenderness) of the broilers of the above study was also assessed by a surrogate marker for meat quality, namely “drip loss” (loss of moisture).

### Results

The following table provides the results of this performance parameter.

Table 5 shows the average drip loss from chicken breast tissue (%)

| Day | aa | A | II | III |
|---|---|---|---|---|
| 0-3 | 5.23 | 5.44 | 4.97 | 5.20 |
| 0-7 | 8.19 | 8.07 | 8.01 | 8.11 |

### Conclusion

The assessment showed that the groups of chickens fed a treatment diet comprising a mixture of a mono-tocopheryl phosphate and a di-tocopheryl phosphate (Group II—10 ppm and Group III 20 ppm) had better results than the groups of chickens not fed the treatment diet comprising a mixture of a mono-tocopheryl phosphate and a di-tocopheryl phosphate.

### Example 5

The following study was conducted to determine the effect of a mixture of a mono-tocopheryl phosphate and a di-tocopheryl phosphate administered to broilers, compared to a control diet with no vitamin E source and the control diet containing a synthetic tocopheryl acetate. In particular, the study compared the effect of these diets on (i) growth performance parameters, with and without heat stress, and (ii) meat quality (tenderness) and plasma biomarkers.

### Treatment Groups

Twenty-four cages of chickens per treatment, each cage containing 5 chickens (i.e. 120 chickens per treatment). Three treatment groups were assessed (eight experimental groups, with each treatment group exposed to normal or heat stress conditions). A total of 360 chickens were used in the study.

### Treatment Period

The treatment period was 35 days (or 5 weeks).

On Day 21, for the last 2 weeks of the study (i.e. Day 21-35), 12 cages per treatment group were split into two treatment groups, namely 12 replicate cages containing 5 chickens in each, in which standard brooding (ST) versus cyclical high temperatures (CHT) was utilised. More specifically, all treatment groups were kept in metabolic cages at standard brooding temperatures until Day 21, and then exposed to either ST (22±1° C. @ RH 60%) or CHT (32±1° C. @ 80-90% RH for 8 h and 22±1° C. @ RH 60% for 16 h).

### Diets

Each group of chickens was fed a starter diet from Day 0-14 post-hatching and then a finisher diet from Day 15-35. These diets did not include any in-feed medications. The diets for the treatment groups were:

Diet 1=control diet, which comprised a feed ration with no vitamin E source (i.e. not in either starter diet nor finisher diet)
Diet 2=the control diet, with 20 ppm tocopheryl acetate (TA) added
Diet 3=the control diet, with 10 ppm of a mixture of a mono-tocopheryl phosphate and a di-tocopheryl phosphate (TPM) added

TABLE A
Composition of diets

| Starter Diet (Day 0-14) | | | Finisher Diet (Day 15-35) | | |
|---|---|---|---|---|---|
| Raw Material | % | (kg) | Raw Material | % | (kg) |
| Wheat 10.5% | 64.77 | 647.7 | Wheat 10.5% | 66.38 | 663.8 |
| Canolameal 37% | 5.0 | 50.0 | Canolameal 37% | 5.0 | 50.0 |
| Soyabeanmeal | 20.2 | 202.0 | Soyabeanmeal | 18.3 | 183.0 |
| 48% | | | 48% | | |
| Meatmeal 57% | 5.0 | 50.0 | Meatmeal 57% | 5.0 | 50.0 |
| Bloodmeal | 0.7 | 7.0 | Bloodmeal | — | — |
| Soya Oil | 2.1 | 21.0 | Soya Oil | 3.5 | 35.0 |
| Salt | 0.07 | 0.7 | Salt | 0.09 | 0.9 |
| Limestone | 0.85 | 8.5 | Limestone | 0.65 | 6.5 |
| Na Bicarbonate | 0.26 | 2.6 | Na Bicarbonate | 0.25 | 2.5 |
| Lysine-HCl | 0.35 | 3.5 | Lysine-HCl | 0.3 | 3.0 |
| D,L-Methionine | 0.29 | 2.9 | D,L-Methionine | 0.25 | 2.5 |
| Threonine | 0.14 | 1.4 | Threonine | 0.1 | 1.0 |
| Isoleucine | 0.09 | 0.9 | Isoleucine | 0.04 | 0.4 |
| L-Arginine | 0.06 | 0.6 | L-Arginine | 0.02 | 0.2 |
| Econase | 0.01 | 0.1 | Econase | 0.01 | 0.1 |
| Phytase | 0.01 | 0.1 | Phytase | 0.01 | 0.1 |
| Poultry Premix* | 0.1 | 1.0 | Poultry Premix* | 0.1 | 1.0 |
| | 100.0 | 1000.0 | | 100.0 | 1000.0 |

*Poultry Premix contains TA or TPM at the required concentrations for Diet 2 and Diet 3 as noted above.

### Assessments

Average individual live-weight gain, average daily gain (ADG), average daily feed intake (ADFI), and feed conversion ratio (FCR), were calculated weekly over the treatment period. Additional performance measurements were also calculated and assessed for Day 0-21, in which ST was maintained for all treatment groups, and for Day 21-35, with treatment groups exposed to either ST or CHT. Treatment groups were also assessed over the entire treatment period.

Data were analysed using the generalised linear model procedure of Statistical Analysis Software. The experimental units were pooled cage means for ADFI and FCR, and the individual chicken for live-weight gain measurements and ADG. Data are presented as means±standard error of the mean (SEM). Meat quality (drip loss/shear force) and plasma biomarker assessments were carried out on representative chickens (1 chicken/cage) at the end of the study.

### Average Live-Weight Gain—Results and Discussion

The effect the different treatment diets had on average live-weight gain (irrespective of housing conditions) is shown in Tables 1 and 2. The effect the different treatment diets had on live-weight gain, under heat stress conditions, is shown in Table 2.

The Diet 3 treatment group had the best results, with chickens heavier, by the end of the treatment period compared to the other two treatment groups. The results also show that Diet 2 had very little effect on average live-weight gain, providing similar results to Diet 1.

The Diet 3 treatment group showed the least reduction in live-weight gain due to CHT. Effectively, the Diet 3 treatment group, and the Diet 1 and Diet 2 treatment groups at ST, and even the Diet 3 treatment group at ST, all showed no significant difference between live-weight gain assessments, indicating that a diet comprising a mixture of a mono-tocopheryl phosphate and a di-tocopheryl phosphate was able to inhibit the effect of heat stress on live-weight gain.

TABLE 1
Average live-weight gain (g)

| Day | Diet 1 | Diet 2 | Diet 3 | SEM |
|---|---|---|---|---|
| D0 | 37.36 | 37.02 | 36.89 | 0.280 |
| D7 | 160.49 | 161.99 | 160.10 | 1.303 |
| D14 | 470.02 | 475.19 | 477.48 | 4.029 |
| D21 | 957.56 | 959.80 | 973.23 | 8.308 |
| D28 | 1650.48 | 1646.58 | 1676.73 | 13.417 |
| D35 | 2455.88 | 2453.53 | 2510.59 | 16.840 |

TABLE 2
Average live-weight gain: ST vs CHT (g)

| | ST | | | CHT | | | |
|---|---|---|---|---|---|---|---|
| Day | Diet 1 | Diet 2 | Diet 3 | Diet 1 | Diet 2 | Diet 3 | SEM |
| D28 | 1679.99 | 1656.28 | 1685.35 | 1620.97 | 1636.87 | 1668.28 | 18.974 |
| D35 | 2511.63 | 2498.07 | 2525.03 | 2400.12 | 2409.00 | 2496.14 | 23.816 |

### Average Daily Gain (ADG)—Results and Discussion

The effect the different diets had on ADG (irrespective of housing conditions) is shown in Table 3. The effect the different treatment diets had on ADG, under heat stress conditions, is shown in Table 4.

As observed in the live-weight gain assessments, the best performing treatment group for ADG assessments was the Diet 3 treatment group.

The effect of heat stress saw significant decreases in ADG for the Diet 1 and the Diet 2 treatment groups, compared to the Diet 3 treatment group. The Diet 1 treatment group showed a decrease in ADG in the two week heat stress period and the entire treatment period respectively, when compared to ST conditions. On the other hand, an overall increase in ADG was observed for the entire treatment period for the Diet 3 treatment group compared to the Diet 1 and the Diet 2 treatment groups.

The Diet 3 treatment group, as observed with the live-weight gain assessments, was the only treatment group that appeared to buck the trend of significant reductions due to heat stress. No significant reduction was seen in the final two weeks of heat stress or overall for this treatment group.

TABLE 3
Average daily gain (g)

| Day | Diet 1 | Diet 2 | Diet 3 | SEM |
|---|---|---|---|---|
| D0-7 | 17.59 | 17.85 | 17.60 | 0.177 |
| D7-14 | 44.22 | 44.74 | 45.34 | 0.462 |
| D14-21 | 69.65 | 69.23 | 70.82 | 0.788 |
| D21-28 | 99.00 | 98.11 | 100.50 | 0.951 |
| D28-35 | 115.06 | 115.28 | 118.26 | 1.526 |
| D21-35 | 107.02 | 106.70 | 109.70 | 0.932 |
| D0-35 | 69.10 | 69.04 | 70.67 | 0.480 |

TABLE 4
Average daily gain: ST vs CHT (g)

| | ST | | | CHT | | | |
|---|---|---|---|---|---|---|---|
| Day | Diet 1 | Diet 2 | Diet 3 | Diet 1 | Diet 2 | Diet 3 | SEM |
| D21-28 | 101.32 | 99.75 | 101.38 | 96.69 | 96.47 | 99.62 | 1.345 |
| D28-35 | 118.81 | 120.25 | 119.98 | 111.31 | 110.30 | 116.54 | 2.158 |
| D21-35 | 110.05 | 110.0 | 110.68 | 104.00 | 103.39 | 108.73 | 1.318 |
| D0-35 | 70.72 | 70.32 | 71.09 | 67.48 | 67.77 | 70.26 | 0.678 |

### Average Daily Feed Intake (ADFI)—Results and Discussion

The effect of the different diets had on ADFI (irrespective of housing conditions) is shown in Table 5. The effect of the different diets had on ADFI, under heat stress conditions, is shown in Table 6.

There was no significant difference observed for ADFI for any of the treatment groups. However, as observed with live-weight gain and ADG performance assessments, the effect of heat stress conditions had significantly impacted ADFI, with significant reductions observed in the Diet 1 and the Diet 2 treatment groups, but not the Diet 3 treatment group. In fact, the latter treatment group had an ADFI on a par with treatment groups maintained at ST conditions.

TABLE 5
Average daily feed intake (g)

| Day | Diet 1 | Diet 2 | Diet 3 | SEM |
|---|---|---|---|---|
| D0-21 | 65.58 | 64.29 | 64.67 | 0.874 |
| D21-35 | 166.17 | 163.64 | 166.97 | 1.317 |
| D0-35 | 98.02 | 96.57 | 97.98 | 0.768 |

TABLE 6
Average daily feed intake (g)

| | ST | | | CHT | | | |
|---|---|---|---|---|---|---|---|
| Day | Diet 1 | Diet 2 | Diet 3 | Diet 1 | Diet 2 | Diet 3 | SEM |
| D21-35 | 170.11 | 167.15 | 166.82 | 162.23 | 160.12 | 167.11 | 1.863 |
| D0-35 | 100.25 | 97.95 | 97.77 | 95.78 | 95.20 | 98.20 | 1.087 |

### Average Feed Conversion Rate (FCR)—Results and Discussion

The effect of the different diets had on FCR (irrespective of housing conditions) is shown in Table 7. The effect of the different diets had on FCR, under heat stress conditions, is shown in Table 8.

FCR was the lowest in the Diet 3 treatment group, and significantly so when compared to the Diet 1 treatment group where reductions were observed.

Again regardless of the housing conditions, the Diet 3 treatment group resulted in the lowest FCR levels.

TABLE 7
Average feed conversion rate (g)

| Day | Diet 1 | Diet 2 | Diet 3 | SEM |
|---|---|---|---|---|
| D0-21 | 1.304 | 1.280 | 1.265 | 0.013 |
| D21-35 | 1.550 | 1.529 | 1.518 | 0.010 |
| D0-35 | 1.419 | 1.399 | 1.387 | 0.007 |

TABLE 8
Average feed conversion (g)

| | ST | | | CHT | | | |
|---|---|---|---|---|---|---|---|
| Day | Diet 1 | Diet 2 | Diet 3 | Diet 1 | Diet 2 | Diet 3 | SEM |
| D21-35 | 1.543 | 1.515 | 1.505 | 1.557 | 1.544 | 1.532 | 0.015 |
| D0-35 | 1.418 | 1.393 | 1.376 | 1.420 | 1.406 | 1.399 | 0.0098 |

### Meat Quality—Results and Discussion

Meat quality (tenderness) was assessed by measuring two parameters following the chickens being sacrificed at the end of the treatment period. The first was (i) “drip loss” (loss of moisture) and the second was (ii) shear force. Breast tissue was used for these assessments, and one breast from one chicken per cage was used for these assessments.

(i) Drip Loss

Breast tissue was removed after sacrifice and a representative sample weighed, suspended in a net in a sealed container to simulate storage and refrigerated. The sample was re-weighed 1 day and 5 days later to allow for the assessment of lost moisture content (or “drip loss”). The lower the “drip loss”, the more moisture retained by the breast tissue, and therefore an indication of improved meat quality (i.e. tenderness).

The average “drip loss” from the tested breast tissues is shown in Tables 9 and 10.

The results show that, after the first 24 hours, none of the diets had an effect on “drip loss”, or moisture content, in the breast tissues. However, after 5 days, breast tissue from the Diet 3 treatment group showed a significantly lower average drip loss in breast tissue compared to the breast tissue from the Diet 2 treatment group.

TABLE 9
Average drip loss of breast tissue (%)

| Day | Diet 1 | Diet 2 | Diet 3 | SEM |
|---|---|---|---|---|
| D0-1 | 2.587 | 3.202 | 2.956 | 0.206 |
| D0-5 | 4.024 | 5.100 | 4.136 | 0.267 |

TABLE 10
Average drip loss of breast tissue (%)

| | ST | | | CHT | | | |
|---|---|---|---|---|---|---|---|
| Day | Diet 1 | Diet 2 | Diet 3 | Diet 1 | Diet 2 | Diet 3 | SEM |
| D0-1 | 2.183 | 3.544 | 3.355 | 2.362 | 2.861 | 2.560 | 0.377 |
| D0-5 | 4.455 | 5.787 | 4.815 | 3.593 | 4.413 | 3.457 | 0.377 |

Treatment groups under CHT showed reduced drip loss compared to treatment groups treated with the same diet in ST conditions (except for Diet 1 treatment group). However, this is likely due to the fact that the chickens under CHT were dehydrated, rather than indicating improved moisture retention. This was confirmed with the shear force results in the following further assessment.

(ii) Shear Force (SF)

Breast tissue was excised, frozen at −20° C., and then thawed and cooked prior to assessment of shear force. Four core samples were removed from each breast sample and assessed for shear force using a texture analyser. This measurement provides an estimate of the tenderness of meat samples after storage and cooking and allows comparative assessments due to treatment. The lower the shear force, the more tender the breast tissue (or breast meat in this case), and therefore an indication of improved tenderness (and thus eating quality).

Average shear force assessments from the breast tissue of chickens is shown in Tables 11 and 12.

TABLE 11
Shear force of breast tissue (g)

| Shear | Diet 1 | Diet 2 | Diet 3 | SEM |
|---|---|---|---|---|
| (g) | 3232.1 | 3180.5 | 3150.1 | 103.48 |

TABLE 12
Shear force of breast tissue (g)

| | ST | | | CHT | | | |
|---|---|---|---|---|---|---|---|
| Shear | Diet 1 | Diet 2 | Diet 3 | Diet 1 | Diet 2 | Diet 3 | SEM |
| (g) | 3064.8 | 2815.1 | 2808.3 | 3399.3 | 3546.0 | 3391.9 | 146.27 |

Preliminary meat quality assessments (i.e. shear force) indicated that the Diet 1 treatment group had the highest SF measurements over the other two treatment groups, whereas the Diet 3 treatment group had the lowest.

Heat stress conditions had a notable effect on the Diet 2 and 3 treatment groups, increasing the SF. These results indicate that the chickens maintained under CHT during the last 2 weeks prior to slaughter had significantly higher shear force values than those chickens maintained under ST conditions. However, the Diet 3 treatment group had lower results than the Diet 2 treatment group.

### Plasma Biomarkers—Results and Discussion

The plasma levels of ten cytokines, namely caronte, interferon gamma (IFNγ), interlekin-6 (IL-6), interleukin-10 (IL-10), interlekin-12p40 (IL-12p40), interleukin-16 (IL-16), interleukin-16 (IL-16), interleukin-21 (IL-21), netrin-2, pentraxin-3 and RANTES, were assessed. The cytokines assayed are known to either induce protective responses and/or induce pathology, and were assessed to provide some insight in monitoring stress, via a snap shot at Day 35 of the level of these biomarkers. These biomarkers can effect commercial production and flock health, and therefore could be used to see if they were reflective of the performance benefit improvements observed in the chickens of the Diet 3 treatment group, and potentially help elucidate a possible mechanism of action in chickens, with or without heat stress conditions, for the various diets.

Plasma was collected from the chickens sampled at the end of the treatment period. Samples were assayed with a Quantibody Chicken Cytokine Array Q1 (RayBiotech, USA) to detect 10 analytes (caronte, IFN-gamma, IL-6, IL-10, IL-12p40, IL-16, IL-21, netrin-2, pentraxin 3, RANTES) according to the manufacturer's protocol. Samples were stored at −80° C. and thawed and mixed prior to testing. Samples were tested as per kit instructions.

Tables 13 and 14 show the plasma mean and SEM of the analytes assayed for each of the treatment groups, either under ST conditions (Table 13) or under CHT conditions, which took place during the final two weeks of the treatment period (Table 14). Please note, three chickens were excluded from the analysis, one from each treatment group. Therefore n=23 for each diet when pooling ST vs CHT. And n=11-12, when assessing the treatments in specific ST and CHT conditions for each diet.

As expected, all of the ten markers assessed were elevated due to heat stress. Under CHT conditions, all of the ten biomarkers were lower for the Diet 3 treatment group compared to the Diet 2 treatment group.

TABLE 13
Plasma Cytokine Concentration (pg/ml), under ST conditions

| | Diet 1 | | Diet 2 | | Diet 3 | |
|---|---|---|---|---|---|---|
| Cytokine | Mean | SEM | Mean | SEM | Mean | SEM |
| Caronte | 1591.1 | 71.71 | 2006.8 | 485.61 | 1518.5 | 59.02 |
| INFy | 423.3 | 67.24 | 388.2 | 39.59 | 379.0 | 29.26 |
| IL-6 | 6110.1 | 1922.31 | 4122.0 | 577.98 | 4332.4 | 511.29 |
| IL-10 | 612.7 | 136.20 | 478.4 | 57.23 | 497.5 | 57.48 |
| IL-12p40 | 17.4 | 1.33 | 19.7 | 2.10 | 19.0 | 2.83 |
| IL-16 | 316.0 | 19.58 | 475.0 | 93.10 | 358.6 | 44.75 |
| IL-21 | 64.4 | 6.97 | 67.1 | 7.83 | 105.2 | 33.56 |
| Netrin-2 | 325.5 | 16.50 | 344.6 | 31.95 | 274.3 | 13.72 |
| Pentraxin 3 | 849.5 | 39.66 | 851.8 | 58.36 | 1638.7 | 581.04 |
| RANTES | 2947.4 | 177.86 | 3683.4 | 846.11 | 2893.8 | 172.89 |

TABLE 14
Plasma Cytokine Concentration
(pg/ml), under CHT conditions

| | Diet 1 | | Diet 2 | | Diet 3 | |
|---|---|---|---|---|---|---|
| Cytokine | Mean | SEM | Mean | SEM | Mean | SEM |
| Caronte | 2127.3 | 129.01 | 2208.5 | 142.62 | 2084.6 | 89.55 |
| INFy | 531.8 | 53.07 | 573.7 | 42.81 | 518.6 | 29.10 |
| IL-6 | 6845.8 | 1148.93 | 7516.5 | 715.56 | 6015.4 | 361.79 |
| IL-10 | 636.5 | 65.88 | 705.3 | 70.80 | 618.7 | 35.74 |
| IL-12p40 | 24.4 | 3.75 | 23.8 | 3.38 | 18.8 | 1.46 |
| IL-16 | 453.0 | 42.51 | 672.8 | 126.64 | 574.3 | 69.75 |
| IL-21 | 102.4 | 11.45 | 119.3 | 14.42 | 104.8 | 10.47 |
| Netrin-2 | 446.8 | 37.42 | 416.6 | 26.45 | 403.4 | 32.93 |
| Pentraxin 3 | 1076.9 | 51.80 | 1042.8 | 59.03 | 988.1 | 85.25 |
| RANTES | 4577.3 | 395.42 | 5085.2 | 476.55 | 4404.1 | 274.06 |

### Conclusions

The current study demonstrates that chickens fed a diet comprising a mixture of a mono-tocopheryl phosphate and a di-tocopheryl phosphate is beneficial to growth performance parameters and improved to meat quality, particularly under heat stress conditions.

More particularly, a mixture of a mono-tocopheryl phosphate and a di-tocopheryl phosphate (the Diet 3 treatment group) saw significant improvements in growth performance parameters, regardless of the housing conditions. In addition, although the effects of heat stress conditions impacted far more greatly with the Diet 1 and the Diet 2 treatment groups, the Diet 3 treatment group fared well. Similarly, a majority of cytokines are elevated due to heat stress conditions. However, the elevated levels were in the most part reduced by the treatment of a mixture of a mono-tocopheryl phosphate and a di-tocopheryl phosphate (the Diet 3 treatment group), which could account for the less impact—on average—with improved growth performance parameters.

Although this invention has been described by example and with reference to possible embodiment thereof, it is to be understood that modifications or improvements may be made thereto without departing from the scope of the invention.

1. A method for improving a performance parameter of an animal comprising administering to the animal a mixture of a mono-tocopheryl phosphate and a di-tocopheryl phosphate, wherein the di-tocopheryl phosphate is in a proportion of at least 10% by weight of the tocopheryl phosphate mixture, wherein the performance parameter is a growth performance parameter.

2. The method of claim 1, wherein the animal is selected from the group consisting of livestock animals, aqua-culture animals, working animals including sports animals, and domesticated companion animals.

3. The method of claim 1, wherein the animal is a livestock animal.

4. The method of claim 1, wherein the animal is a juvenile.

5. The method of claim 1, wherein the mixture of a mono-tocopheryl phosphate and a di-tocopheryl phosphate is orally administered to the animal.

6. The method of claim 1, wherein the mixture of a mono-tocopheryl phosphate and a di-tocopheryl phosphate is added to a ration of animal feed to be consumed by the animal.

7. The method of claim 6, wherein the ration of animal feed is a starter diet, a finisher diet, or a combination of both.

8. The method of claim 7, wherein the ration of animal feed comprises a mixture of a mono-tocopheryl phosphate and a di-tocopheryl phosphate in an amount from about 1 ppm to about 1,000 ppm.

9. The method of claim 8, wherein the ration of animal feed comprises a mixture of a mono-tocopheryl phosphate and a di-tocopheryl phosphate in an amount from about 5 ppm to about 160 ppm.

10. The method of claim 9, wherein the ration of animal feed comprises a mixture of a mono-tocopheryl phosphate and a di-tocopheryl phosphate in an amount of about 5 ppm, or about 10 ppm, or about 20 ppm, or about 40 ppm, or about 80 ppm.

11. The method of claim 1, wherein the performance parameter is improved under stressed conditions in commercial production environments.

12. The method of claim 1, wherein the growth performance parameter is selected from the group consisting of live-weight gain and feed efficiency.

13. The method of claim 12, wherein feed efficiency is selected from average daily gain, average daily feed intake and feed conversion ratio.
